(19) United States
(12) Patent Application Publication
(10) Pub. No.: US 2012/0030000 A1
(43) Pub. Date: Feb. 2, 2012

(54) System and method for calculating loyalty points based on usage of consumer energy

(76) Inventors: Jamal Hanini, (US); Samer Hanini, (US)

(21) Appl. No.: 13/136,233

(22) Filed: Jul. 27, 2011

Related U.S. Application Data
(60) Provisional application No. 61/368,019, filed on Jul. 27, 2010.

(51) Int. Cl. G06Q 30/00; G06F 1/32

(52) U.S. Cl. 705/14.31

(57) ABSTRACT

A system of the present invention allows owners of various commercial establishments including and not limited to hotels, motels, and any other commercial establishments that rent or lease spaces for short terms or long term use to patrons to provide the patron with incentives such as loyalty points (“green points”) in exchange for the patron's efficient and economical use of consumer energy. The system includes several components operably communicated with one another for calculating usage of electricity and water, compare actual usage of electricity and water with a predetermined amount or value of electricity and water usage for a particular premises such as a room in the hotel, a rental apartment, an office space and the like based on a season, geographic location of the premises.

### RELATED APPLICATIONS

This is a non-provisional application that claims priority to a provisional application Ser. No. 61/368,019 filed on Jul. 27, 2010 and incorporated herewith by reference in its entirety.

### FIELD OF THE INVENTION

The present invention relates to a system and method for calculating and awarding loyalty points or other incentives to consumers.

### BACKGROUND OF THE INVENTION

Importance of efficient use of energy and water has been realized all over the world as never before. The measures of energy efficiency are useful in multiple ways. Reduced use of fossil fuels is essential in lowering the emission of greenhouse gases contributing to global warming. The policies for energy efficiency aim to minimize the use of fossil fuels, thereby preventing the occurrence of adverse climatic change resulting from it. Energy efficiency reduces electricity consumption and helps in saving money.

It is important to come up with a solution that will improve conservation of energy not only in private homes but also in various commercial establishments such as hotels, motels, and the like. Guests who check in to the hotel or motel do not pay attention or even think about using electricity and water economically. Sometimes the guest may turn on the lights in his/her room and leave the lights and even water on for a long period of time. Management and owners of the hotels and motels do not provide the guest with some type of incentives to make the guests to use the electricity and water efficiently and economically. There are different ways of attracting the attention of people and providing some sort of incentive in return to certain acts. One of such ways is loyalty programs (also known as incentive or reward programs). Loyalty programs are typically very popular in many types of businesses. For example, loyalty programs may be implemented to increase the use of a product by a current customer or to obtain additional customers. With regard to transaction cards, such as charge cards, loyalty programs may encourage a loyalty program participant to use a particular transaction card for making acquisitions.

Typically, loyalty points accrue in a loyalty account and are earned from transactions that involve participant behavior that is encouraged by the loyalty program sponsor. These loyalty points may be redeemed for prizes, upgrades, and merchandise, thus rewarding the participant for the behavior. However, prior art loyalty point redemption processes lack “real-time” use by the participant. For instance, in a typical redemption process, a participant calls the loyalty system and requests to redeem a number of loyalty points in exchange for a certificate that can be used at a particular merchant (on-line or off-line). The participant is mailed a certificate (or provided with an online code) and then can redeem the certificate at that merchant.

The art is replete with various prior art systems and methods for creating loyalty programs and assigning loyalty points to users, participants, and the like. These prior art patents, such as U.S. Pat. No. 5,937,391 to Ikeda et al., U.S. Pat. No. 5,774,870 to Storey, U.S. Pat. No. 5,025,372 to Henke et al., U.S. Pat. No. 6,009,412 to Storey, and U.S. Pat. No. 7,680,688 to Hessburg et al., illustrate recent efforts to create more attractive loyalty systems. The U.S. Pat. No. 5,937,391 to Ikeda et al. is directed to an improved method of accumulating, managing, and redeeming points with a point-service system in an online shopping mall established through a network. This system utilizes point accumulation and points redemption ratios based on particular vendors in order to vary the amount of points awarded and the value of points redeemed. This system is limited, however, to a participating network of vendors that accept redemption of points for product, i.e., this system is not compatible with merchants who do not accept points and are not integrated into a shopping mall. This system is also directed to managing, within a network of participating vendors, the accumulation of points from one vendor (with a particular accumulation ratio) and redemption of points with another vendor (with another redemption ratio).

The U.S. Pat. No. 5,774,870 to Storey and U.S. Pat. No. 6,009,412 to Storey relate to an online, interactive frequency and award redemption program which immediately awards and issues bonus points to a user's awards account in response to that user's online purchase of merchandise. In other words, submission of a purchase order form during an online session results in the calculation and addition of points to an enrolled user's account as well as the display of current account information. The user is then immediately permitted to redeem any or all of the award points in the user's account, including currently awarded points, in that same online session. This system is specifically directed to expediting the award and redemption of points for product. Therefore, this invention is limited to redeeming points within a redemption network of merchants who accept points.

Finally, the U.S. Pat. No. 5,025,372 to Henke et al., generally relates to an incentive award program which allocates monetary amounts of credit based on a participant's performance of a designated level of achievement. The monetary amounts can be withheld and/or adjusted by a sponsoring company. Although this system allows for the crediting of a monetary value to a credit instrument, it is limited in that the participant is not able to interact over a computerized network with this system so as effect a real-time transaction or to effect a real time credit to a credit instrument. Although many of these programs have been successful in developing customer loyalty and incenting customers to act, they have presented participants with limited opportunities to redeem loyalty points for the products of their choice or have provided participants with limited accessibility and control of their loyalty account.

None of the aforementioned prior art references provides a system and method that can be implemented in commercial establishments such as hotels, motels, wherein people will rent premises to reside, rest, or even rent the premises for commercial purposes in order to provide incentives to people in exchange for use of electricity and water in efficient and economic fashion.

Therefore, a need exists in this industry for system and method that will solve the problems associated with prevention of energy waste and providing people with incentives to use energy and water economically and efficiently.

### SUMMARY OF THE INVENTION

A system and method of the present invention allows owners of various commercial establishments including and not limited to hotels, motels, and any other commercial establishments that rent or lease spaces for short terms or long term use to patrons to provide the patron with incentives such as loyalty points or so called “green points” in exchange for efficient and economical use of electricity, water, gas, and any other forms of consumer energy. The system includes several components operably communicated with one another for calculating usage of electricity and water, compare actual usage of electricity and water with predetermined amount or value of electricity and water usage for a particular premises such as a room in the hotel, a rental apartment, an office space and the like based on a season, geographic location of the premises. The system will generate the green points to be awarded to the patron if amount of electricity and water actually used by the patron during his occupancy of the premises meets the predetermined amount or value or even falls below the predetermined amount or value.

The system includes a usage interface device installed on every premises. Alternatively, the usage interface device may be located at a remote location and will be adaptable to receive information wirelessly. The usage interface device determines amount of electricity, water, and gas used at the premises. The usage interface device is operably communicated with a central processing unit (the CPU). The usage interface device may also include a screen installed on the premises such as hotel rooms informing the guest or the patron about the level of average use of consumer energy such as water and electricity and the level of actual use of consumer energy as used by the guest. This information presented to the guest will alert the guest about the possibility of saving consumer energy when the guest will see comparison between these two levels.

The CPU includes a comparator device installed therein, a user interface device, and a database device. The user interface device received information from a desk computer as the patron checks in to the hotel. The information may include name and email address of the patron in order to email the patron information about the green point if the patron did in fact earned these green points.

The database device includes information about size of each premise, average amount of electricity and water to be used based on time of the year and number of patrons using the premises. The comparator device compares the amount of electricity, water, and gas used by the patron while he used the premises and compared the amount with the predetermined amount or value of electricity and water usage for the particular premises to determine if there is a match between two values or if the value of actual usage is above or below the predetermined amount or value. A point generating software is integrated with the CPU. The point generating software receives information from the comparator device if the actual amount or value of electricity, water, and gas meets the predetermined amount or value of electricity and water usage for the particular premises.

Here, the point generating software will issue number of the green points to be emailed or texted or awarded to the account of the patron. The number of the green point will also be posted on the patron's file created in the database as the patron checks in to the establishment. The patron will be able to redeem this green point in exchange for a discount of a room next time when the patron decides to stay in the same hotel or any other hotels of the same owner. The green points can also be traded or sold for cash to other companies unrelated to the owners of the hotels and other premises where these green points were earned.

An advantage of the present invention is to provide a system and method that will allow the owners of the commercial establishments such as hotels, motels, and office buildings to attract the patrons and tenants to rent the establishment over and over again by providing them with incentives such as green points generated based on the amount of electricity and water used by the patrons as the patrons rent the premises.

Another advantage of the present invention is to provide a system and method that will allow the owners of the commercial establishments such as hotels, motels, and office buildings to save on the usage of electricity, water, and gas by providing the patrons and tenants, renting the establishment with incentive points that the patrons will earn if the patron will use electricity, water, and gas on as needed based thereby eliminating waste of the same and enjoying reduced rate on future deals.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates a schematic view of a system architecture of the present invention; and

FIG. 2 illustrates a schematic view of an alternative embodiment of the system architecture of the present invention.

### DESCRIPTION OF THE INVENTION

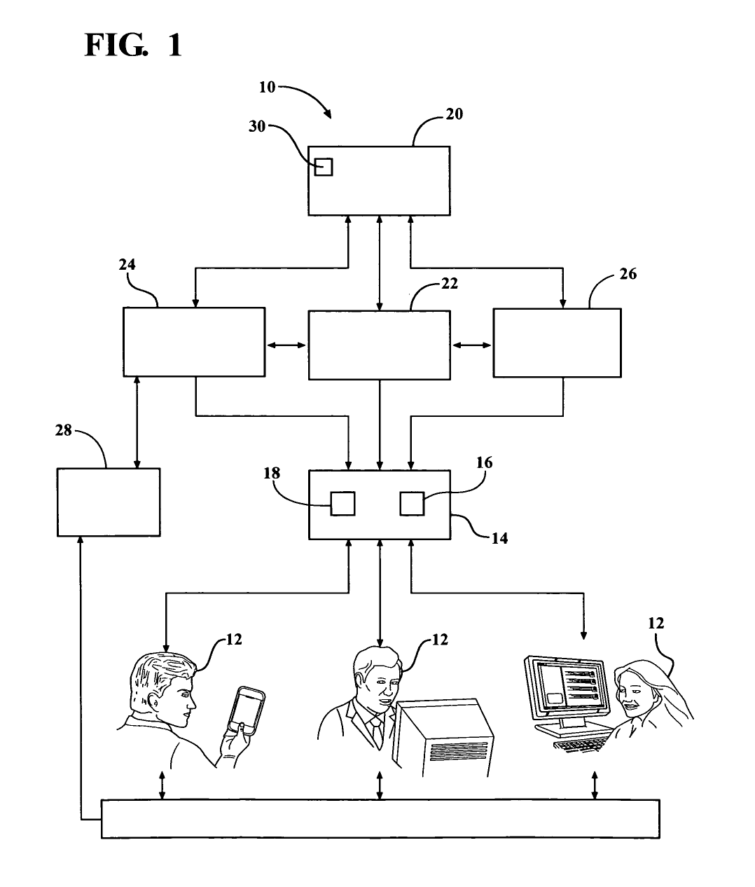

Referring to FIG. 1, wherein like numerals indicate like or corresponding parts throughout the several views, a system of the present invention is generally shown at 10 in FIG. 1. The system 10 and the method allow owners of various commercial establishments including and not limited to hotels, motels, and any other commercial establishments such as office building, to be referred further below as premises, that rent or lease the premises for short terms or long term use to guests, tenants, to be referred further below patrons 12 to provide the patron 12 with incentives such as loyalty points or so called “green points” in exchange for the patrons 12 efficient and economical use of electricity, water, gas, and any other forms of consumer energy, to be referred further below as the consumer energy without limiting the scope of the present invention.

The system 10 includes several components operably communicated with one another to calculate usage of electricity and water, compare actual usage of electricity and water with a predetermined amount or value of electricity and water usage for a particular premises such as a room in the hotel, a rental apartment, an office space and the like based on a season, geographic location of the premises. The system 10 will generate the green points to be awarded to the patron 12 if amount of electricity and water actually used by the patron 12 during his occupancy of the premises meets the predetermined amount or value or even falls below the predetermined amount or value.

The system 10 includes a usage interface device 14 installed in on every premise, such as a room in the hotel, a rental apartment in a rental community, or an office located in the commercial establishment. The usage interface device 14 determines amount of electricity, water, and gas used at the premises. In particular, the usage interface device 14 includes a water meter device 16 and an electric meter device 18. The water meter device 16 is used to track actual amount of water used on the premises, such as bathroom water usage, kitchen water usage, and other water usage. The electric meter device 18 is used to calculate the amount of electricity used on the premises, such as appliances usage, all lighting usage, all cooling and heating supply usage, and other electrical usage, bathroom water usage, kitchen water usage, and other water usage. The usage interface device 14 may also include other devices used to calculate the usage of other types of consumer energy such as gas and other fluids. The usage interface device 14 may also include a screen installed on the premises such as hotel rooms informing the guest or the patron about the level of average use of consumer energy such as water and electricity and the level of actual use of consumer energy as used by the guest. This information presented to the guest will alert the guest about the possibility of saving consumer energy when the guest will see comparison between these two levels.

The usage interface device 14 is operably communicated with a central processing unit (the CPU) 20. The CPU 20 is cooperable with a comparator device 22, a user interface device 24, and a database device 26. The user interface device 24 receives information from a desk computer 28 located on the premises that receives information from the patron as the patron checks in to the hotel or rents the premises in the commercial establishment. The information may include name and email address of the patron 12 in order to email the patron information about the green point if the patron did in fact earned these green points. The information also includes location and size of the room the patron 12 checked in, duration of the patron's 12 stay, number of the patrons 12 to be stayed in the room.

The database device 26 includes information about size of each premise, average amount of electricity and water to be used based on time of the year and number of patrons using the premises. The database 26 also includes the average amount of all appliances usage, all lighting usage, all cooling and heating supply usage, and other electrical usage, bathroom water usage, kitchen water usage, and other water usage. The comparator device 22 compares the amount of electricity, water, and gas used by the patron 12 while he used the premises and compare the amount with the predetermined amount or value of electricity and water usage for the particular premises to determine if there is a match between two values or if the value of actual usage is above or below the predetermined amount or value.

A point generating software 30 is integrated with the CPU 20. The point generating software 30 receives information from the comparator device 22 if the actual amount or value of electricity, water, and gas meets or falls below the predetermined amount or value of electricity and water usage for the particular premises. Here, the point generating software 30 will issue number of the green points to be emailed or texted to the patron. The current status of the green points will be reflected on the patron's 12 account in the database of the commercial establishment.

The patron 12 will be able to redeem this green point in exchange for a discount of a room next time when the patron decides to stay in the same hotel or any other hotels of the same owner or chain. The green points may also be redeemed for other products and services provided by the commercial establishment. The green points can also be traded or sold for cash to other companies unrelated to the owners of the hotels and other premises where these green points were earned.

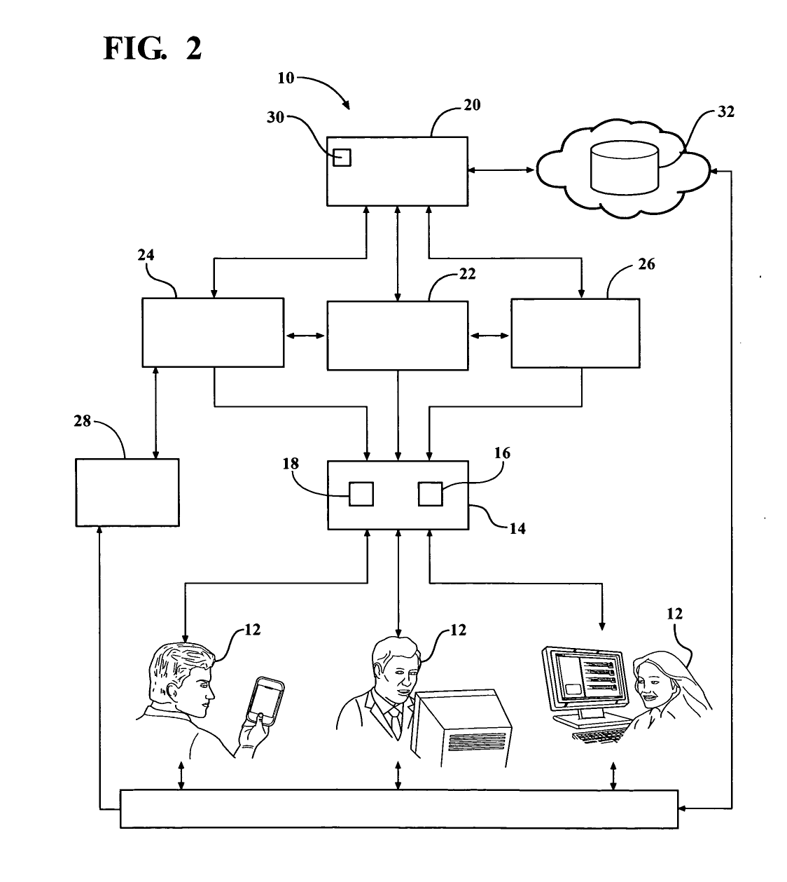

As shown in FIG. 2, an alternative embodiment of the present invention includes a global positioning system (the GPS) wirelessly communicated with the CPU 20 to allow the GPS 32 to alert the patrons 12 who earned the green points about any offers available to the patrons 12 as the patrons 12 pass near by any other facilities that are part of the commercial establishment where the patrons 12 earned the green point. The GPS 32 will receive information such as the patrons 12 mobile phone numbers in order for the GPS 32 to locate the patrons 12 and alert the patrons 12 about the offers as the patrons 12 located within the proximate distance from the commercial establishments. The users 12 may choose not to use these offers at that particular time. In this case, the green points will be credited to the user's account for future sale or exchange.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A system for determining usage of consumer energy at a commercial establishment by a user occupying the commercial establishment and generating loyalty points to be awarded to the user and to be redeemed by the user at the commercial establishment, said system comprising;
a first device for tracking actual use of consumer energy with said first device positioned at premises of the commercial establishment to calculate amount of consumer energy used by the user as the user occupied the premises;
a second device for storing predetermined information about average use of the consumer energy including at least one of size of the premises, geographic location of the premises, number of users occupying the premises and type of consumer energy;
a third device for receiving contact information from the user as the user checks in to the commercial establishment in order to occupy the premises,
a central processing unit operably communicated with said first, second, and third devices for receiving information about said average use from said second device and comparing said average use with information about actual use of consumer energy received from said first device about said amount of consumer energy used by the user as the user occupied the premises; and
a forth device cooperable with said central processing unit for generating loyalty point in response from information provided by said central processing unit as said central processing unit identifies if said actual use matches said average use and falls below said average use and awarding said loyalty points to the user thereby allowing the user to further redeem said loyalty points at the commercial establishment thereby saving consumer energy at the commercial establishment.

2. A system as set forth in claim 1, wherein said first device for tracking actual use of consumer energy positioned at premises of the commercial establishment to calculate amount of consumer energy used by the user as the user occupied the premises is further defined by a fluid usage meter and an electric energy usage meter.

3. A system as set forth in claim 2, wherein said second device is further defined by a database device including information about size of each premise, average amount of electricity and water to be used at the premises based on a season and number of the users occupying the premises.

4. A system as set forth in claim 3, including a global positioning system (GPS) cooperable with said central processing unit to allow said GPS to alert the user who earned said loyalty points about offers available to the user as the user is positioned near any other commercial establishment where said loyalty points were earned and can be redeemed and alerting the user about the offers.

5. A computer generated method for determining usage of consumer energy at a commercial establishment by a user occupying the commercial establishment and generating loyalty points to be awarded to the user and to be redeemed by the user at the commercial establishment, said method comprising the steps of;
interconnecting a first device and a second device to track actual use of consumer energy positioned at premises of the commercial establishment to calculate amount of consumer energy used by the user as the user occupied the premises and storing predetermined information about average use of the consumer energy including at least one of size of the premises, geographic location of the premises, number of users occupying the premises and type of the consumer energy;
connecting a third device to the first and second devices to receive contact information from the user as the user checks in to the commercial establishment in order to occupy the premises,
connecting a central processing unit to the first, second, and third devices to receive information about the average use from the second device to compare the average use with information about actual use of consumer energy received from the first device about the amount of consumer energy used by the user as the user occupied the premises; and
connecting a forth device to the central processing unit to generate loyalty point in response from information provided by the central processing unit as the central processing unit identifies if the actual use matches the average use and falls below the average use thereby awarding the loyalty points to the user to allow the user to further redeem the loyalty points at the commercial establishment to save consumer energy at the commercial establishment.

6. A method as set forth in claim 5, wherein interconnecting a first device and a second device to track actual use of consumer energy positioned at premises of the commercial establishment thereby calculating amount of consumer energy used by the user as the user occupied the premises and storing predetermined information about average use of consumer energy including at least one of size of the premises, geographic location of the premises, number of users occupying the premises and type of consumer energy is further defined by connecting a fluid usage meter and an electric energy usage meter to the first device.

7. A method as set forth in claim 5, wherein interconnecting a first device and a second device to track actual use of consumer energy positioned at premises of the commercial establishment thereby calculating amount of consumer energy used by the user as the user occupied the premises and storing predetermined information about average use of consumer energy including at least one of size of the premises, geographic location of the premises, number of users occupying the premises and type of consumer energy is further defined by connecting a database device including information about size of each premise, average amount of electricity and water to be used at the premises based on a season and number of the users occupying the premises.

8. A method as set forth in claim 5, including the step of connecting a global positioning system (GPS) to the central processing unit to allow the GPS to alert the user who earned the loyalty points about offers available to the user as the user is positioned near any other commercial establishment where the loyalty points were earned and can be redeemed and alerting the user about the offers.
